(19) United States
(12) Patent Application Publication
(10) Pub. No.: US 2025/0125707 A1
(43) Pub. Date: Apr. 17, 2025

(54) TRANSFORMER DEVICE AND DRIVE CIRCUIT

(71) Applicant: Novatek Microelectronics Corp., Hsinchu (TW)

(72) Inventors: Yi Jung Tu, Taoyuan City (TW); Hung Teng Yeh, Hsinchu City (TW)

(73) Assignee: Novatek Microelectronics Corp., Hsinchu (TW)

(21) Appl. No.: 18/402,652

(22) Filed: Jan. 2, 2024

(30) Foreign Application Priority Data
Oct. 11, 2023 (TW) 112138648

(51) Int. Cl. H02M 1/00; H02M 3/335

(52) U.S. Cl. CPC H02M 1/0032; H02M 1/0009; H02M 1/0048; H02M 3/33569

(57) ABSTRACT

A transformer device and a drive circuit are provided. The transformer device includes an alternating current (AC) input terminal, a bridge rectifier circuit, a high-frequency voltage conversion circuit, a power switch circuit, an optical coupling circuit, a zero voltage and operation voltage dividing circuit, and a primary-side controller. The power switch circuit is controlled by a driving signal. The primary-side controller operates according to an operating voltage. The primary-side controller sets itself to one of multiple operating modes according to a load detection signal provided by the optical coupling circuit and a zero voltage detection signal provided by the zero voltage and operation voltage dividing circuit, and adjusts an amplitude and a frequency of a PWM signal in the driving signal according to the set operating mode. The operating mode at least includes a first load mode, a second load mode, and a standby mode.

### CROSS-REFERENCE TO RELATED APPLICATION

This application claims the priority benefit of Taiwan application serial no. 112138648 filed on Oct. 11, 2023. The entirety of the above-mentioned patent application is hereby incorporated by reference herein and made a part of this specification.

### BACKGROUND

### Technical Field

The disclosure relates to a voltage conversion technology from alternating current (AC) to direct current (DC), and in particular relates to a transformer device and a drive circuit for the transformer device.

### Description of Related Art

As energy conservation and environmental protection become a consensus, electronic products ranging from smartphones to household appliances are required to comply with numerous international energy efficiency standards. These energy-saving standards all have specifications for standby power consumption. The “standby power consumption” refers to the power consumed by electronic products under very light or zero load conditions, which is known as standby power consumption.

As technology evolves, these energy-saving standards are becoming more stringent. These energy-saving standards are, for example, the level 6 standard set by the US Department of Energy (DoE) (standby power consumption must be less than 100 mW), the tier 2 standard set by the European Union Code of Conduct (CoC) standard (standby power consumption must to be less than 75 mW), Energy Star certification, Blue Angel certification . . . etc.

Although various technologies have been used to reduce the standby power consumption of electronic products in the past, the aforementioned energy-saving standards have imposed stricter restrictions on standby power consumption. Therefore, how to comply with the aforementioned energy-saving standards in terms of standby power consumption is a major technical problem for power supply design in electronic products.

### SUMMARY

A transformer device and a drive circuit for the transformer device, which save power consumption by adjusting a driving signal configured to control a power switch, are provided in the disclosure.

The transformer device of the disclosure includes an alternating current (AC) input terminal, a bridge rectifier circuit, a high-frequency voltage conversion circuit, a power switch circuit, an optical coupling circuit, a zero voltage and operation voltage dividing circuit, and a primary-side controller. The AC input terminal provides AC voltage. The bridge rectifier circuit converts the AC voltage into a first voltage. The high-frequency voltage conversion circuit includes primary winding, secondary winding, and auxiliary winding. The power switch circuit is coupled to the primary winding. The power switch circuit is controlled by a driving signal. The high-frequency voltage conversion circuit converts the first voltage into a DC voltage according to the primary winding, the secondary winding, and the power switch circuit. The optical coupling circuit generates a load detection signal according to the DC voltage. The zero voltage and operation voltage dividing circuit maps an operating voltage proportional to an output voltage according to the auxiliary winding to provide a zero voltage detection signal. The primary-side controller is coupled to the optical coupling circuit and the power switch circuit. The primary-side controller operates according to the operating voltage. The primary-side controller sets the primary-side controller to one of multiple operating modes according to the load detection signal and the zero voltage detection signal, and adjusts an amplitude and a frequency of a pulse width modulation (PWM) signal in the driving signal according to a set operating mode. The operating mode at least includes a first load mode, a second load mode, and a standby mode.

A drive circuit of the disclosure is configured to drive a transformer device. The drive circuit includes a load detection terminal, a zero voltage detection terminal, an operating voltage mapping terminal, a mode selection circuit, a mode type undervoltage lockout circuit, a drive amplitude adjustment circuit, a drive frequency adjustment circuit, and a buffer. The load detection terminal obtains a load detection signal. The zero voltage detection terminal obtains a zero voltage detection signal. The operating voltage mapping terminal obtains an operating voltage, in which the drive circuit operates according to the operating voltage. The mode selection circuit compares the load detection signal and a load threshold to generate a first detection signal, compares the zero voltage detection signal and a system power supply threshold to generate a second detection signal, and generates a mode selection signal according to the first detection signal and the second detection signal. The mode type undervoltage lockout circuit is coupled to the mode selection circuit. The mode type undervoltage lockout circuit selects one of multiple first candidate reference voltages as a first reference voltage according to the mode selection signal, and compares the first reference voltage with a divided voltage signal corresponding to the operating voltage to generate an undervoltage lockout signal. The drive amplitude adjustment circuit is coupled to the mode selection circuit. The drive amplitude adjustment circuit selects one of multiple second candidate reference voltages as a second reference voltage according to the mode selection signal, and determines an amplitude of a pulse width modulation (PWM) signal in a driving signal according to the second reference voltage and the operating voltage. The driving signal is configured to drive the power switch in the transformer device. The drive frequency adjustment circuit is coupled to the mode type undervoltage lockout circuit. The drive frequency adjustment circuit determines a frequency of the PWM signal in the driving signal according to the load detection signal, the zero voltage detection signal, and the undervoltage lockout signal. A power supply terminal of the buffer is coupled to an output terminal of the drive amplitude adjustment circuit. An input terminal of the buffer is coupled to an output terminal of the drive frequency adjustment circuit. The buffer is configured to generate the PWM signal in the driving signal.

Based on the above, the transformer device and the drive circuit for the transformer device of the embodiment of the disclosure determine whether the current operating mode of the drive circuit is a heavy load mode, a light load mode, or a standby mode by using the load detection signal and the zero voltage detection signal, thereby correspondingly adjust the amplitude and frequency of the PWM signal in the driving signal according to these operating modes. Specifically, in the heavy load mode, the amplitude and frequency of the PWM signal in the driving signal are normal, and the operating voltage of the drive circuit has not been adjusted. In light load mode, the amplitude of the PWM signal in the driving signal is reduced, and the frequency of the PWM signal may also be reduced to reduce the switching loss of the power switch. Moreover, the operating voltage of the drive circuit may also be slightly lowered in the light load mode, thereby reducing the static power consumption of the drive circuit. In standby mode, in addition to the operating voltage of the drive circuit being reduced, the amplitude of the PWM signal in the driving signal is also reduced. The generation of PWM signal in the driving signal is also stopped according to the load detection signal to avoid switching loss of the power switch. Thereby, the transformer device and its drive circuit of this embodiment may further save power consumption.

### BRIEF DESCRIPTION OF THE DRAWINGS

FIG. 1 is a schematic diagram of a transformer device according to the first embodiment of the disclosure.

FIG. 2 is a schematic diagram of the PWM signal frequency in the load detection signal and the driving signal in the transformer device of FIG. 1.

FIG. 3 is a waveform diagram of the load detection signal and the driving signal in the transformer device of FIG. 1.

FIG. 4 is a waveform schematic diagram of the operating voltage, driving signal, and time of the primary-side controller in the transformer device of FIG. 1.

FIG. 5 is a schematic diagram of a transformer device according to the second embodiment of the disclosure.

FIG. 6 is a detailed circuit diagram of the primary-side controller of FIG. 5.

FIG. 7 is a waveform schematic diagram of the operating voltage, driving signal, and time of the primary-side controller in the transformer device of FIG. 5.

FIG. 8 is a detailed circuit diagram of a primary-side controller in accordance with the third embodiment of the disclosure.

### DETAILED DESCRIPTION OF DISCLOSED EMBODIMENTS

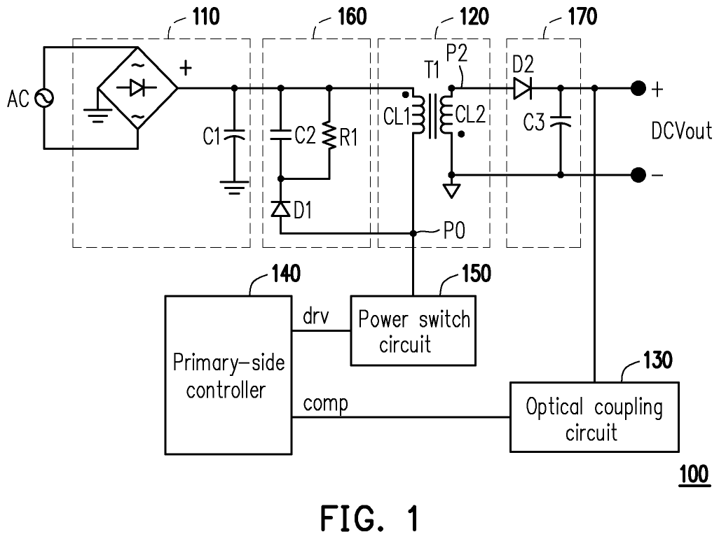

FIG. 1 is a schematic diagram of a transformer device 100 according to the first embodiment of the disclosure. The transformer device 100 mainly includes a bridge rectifier circuit 110, a high-frequency voltage conversion circuit 120, an optical coupling circuit 130, a primary-side controller 140, and a power switch circuit 150. The transformer device 100 also includes a snubber circuit 160 and an output rectifier circuit 170. The primary-side controller 140 may also be referred to as a drive circuit of the transformer device 100. The primary-side controller 140 may be implemented in chip form.

The alternating current (AC) voltage is provided to the bridge rectifier circuit 110 through the AC input terminal AC. The bridge rectifier circuit 110 converts the AC voltage into the voltage (first voltage) on the terminal P1 by using the diode bridge and the capacitor C1. The voltage at terminal P0 is dampened by the capacitor C2, resistor R1, and diode D1 in the buffer circuit 160.

The high-frequency voltage conversion circuit 120 mainly includes a primary winding CL1 and a secondary winding CL2. The output rectifier circuit 170 includes a diode D2 and a capacitor C3. The high-frequency voltage conversion circuit 120 converts the voltage at the terminal P1 into a direct current (DC) voltage at the terminal P2 through the relationship of the number of coils between the two windings CL1 and CL2 and the turn-on frequency of the power switch in the power switch circuit 150. The turn-on frequency of the power switch in the power switch circuit 150 is controlled by the driving signal drv. The voltage on the terminal P2 is also affected by the output rectifier circuit 170 and stabilized, thereby generating the voltage on the DC output terminal DCVout.

The optical coupling circuit 130 generates the load detection signal comp according to the DC voltage on the DC output terminal DCVout. The load detection signal comp is configured to detect the load level on the DC output terminal DCVout. When the voltage value of the load detection signal comp is high, it indicates that the load of the transformer device 100 is heavy; when the voltage value of the load detection signal comp is low, it indicates that the load of the transformer device 100 is light. The primary-side controller 140 determines the load level of the transformer device 100 on the DC output terminal DCVout according to the load detection signal comp and adjusts the driving signal drv on the driving voltage terminal DRV. The driving signal drv in this embodiment is a pulse width modulation (PWM) signal. For convenience of explanation, this embodiment divides the load level on the DC output terminal DCVout into four states: a heavier load situation is referred to as the heavy load state; a medium load situation is referred to as a medium load state; a lighter load situation is referred to as a light load state; a very light load or even zero load situation is referred to as a no-load state.

In this embodiment, the primary-side controller 140 may reduce the standby power consumption by reducing its own operating voltage and reducing the switching frequency configured to control the switching of the power switch circuit 150 in the driving signal drv. The reason is that when the transformer device 100 is under light load or standby no-load condition, the main factors affecting the power consumption are the static power consumption of the primary-side controller 140 (i.e., the power value obtained by multiplying the primary-side controller 140 by the static current) and the switching loss caused by the power switch circuit 150 through the control of the driving signal drv, which switches the power switch in the power switch circuit 150.

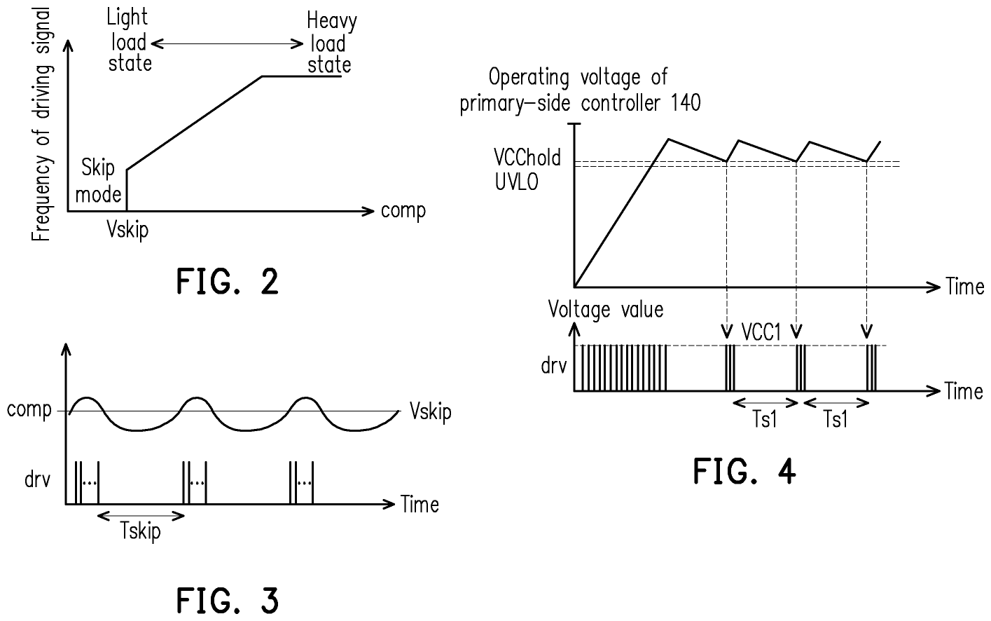

FIG. 2 is a schematic diagram of the PWM signal frequency in the load detection signal comp and the driving signal drv in the transformer device 100 of FIG. 1. FIG. 3 is a waveform diagram of the load detection signal comp and the driving signal drv in the transformer device 100 of FIG. 1. Referring to FIG. 1 to FIG. 3 at the same time, when the load of the transformer device 100 is adjusted from a heavy load state to a light load state, the primary-side controller 140 may be informed of changes of the load in the transformer device 100 based on the load detection signal comp. For example, when the voltage value of the load detection signal comp drops below a predetermined voltage (e.g., voltage Vskip), the primary-side controller 140 enters the skip mode and sets the PWM signal frequency in the driving signal drv to zero during the time Tskip to stop the switching of the power switch in the power switch circuit 150, thereby reducing the switching loss. When the voltage of the load detection signal comp rises and is greater than the predetermined voltage (e.g., voltage Vskip), which may be caused by insufficient energy at the DC output terminal DCVout in FIG. 1 or an increase in load, the primary-side controller 140 continues to generate the driving signal drv to continue switching the power switch in the power switch circuit 150.

Each switching of the power switch still causes power loss. Therefore, in addition to reducing the number of switching times of the power switch by controlling the driving signal drv, embodiments of the disclosure may also reduce the ability of the primary-side controller 140 to drive the power switch (e.g., reducing the voltage of the driving signal drv) to reduce standby power consumption, that is, reduce switching loss.

On the other hand, referring to FIG. 4, FIG. 4 is a waveform schematic diagram of the operating voltage, driving signal DRV, and time of the primary-side controller 140 in the transformer device 100 of FIG. 1. Since the conduction loss of the primary-side controller 140 needs to be considered under medium and heavy loads, the primary-side controller 140 is set to operate at a voltage VCChold slightly higher than the minimum voltage UVLO, so that the operating voltage of the primary-side controller 140 must be maintained at least above the minimum voltage UVLO to maintain the voltage value of the driving signal drv for driving the power switch. As long as the operating voltage of the primary-side controller 140 is lower than the voltage VCChold, this embodiment increases the operating voltage of the primary-side controller 140 to prevent the operating voltage of the primary-side controller 140 from being lower than the minimum voltage UVLO and causing the primary-side controller 140 to be turned off and unable to operate. However, this means that it is difficult to further reduce the static power consumption of the primary-side controller 140 by reducing the operating voltage of the primary-side controller 140. On the other hand, time Ts1 in FIG. 4 indicates that the driving signal drv is in the output pulse burst period. The longer the output pulse burst period of the driving signal drv, the longer the overall system stop time period of the transformer device 100, and the lower the switching loss.

In order to achieve a balance between the conduction loss in the medium load and heavy load states and the switching loss in the light load and no-load states, the disclosure proposes another embodiment (the second embodiment) to adjust the minimum operating voltage of the primary-side controller 140 and the voltage value of the driving signal drv to normal values under medium load and heavy load states through the primary-side controller 140. Moreover, under light load and no-load states, the primary-side controller 140 may reduce static power consumption by reducing its own operating voltage, and synchronously reduce the amplitude and frequency of the PWM signal in the driving signal drv to reduce switching losses.

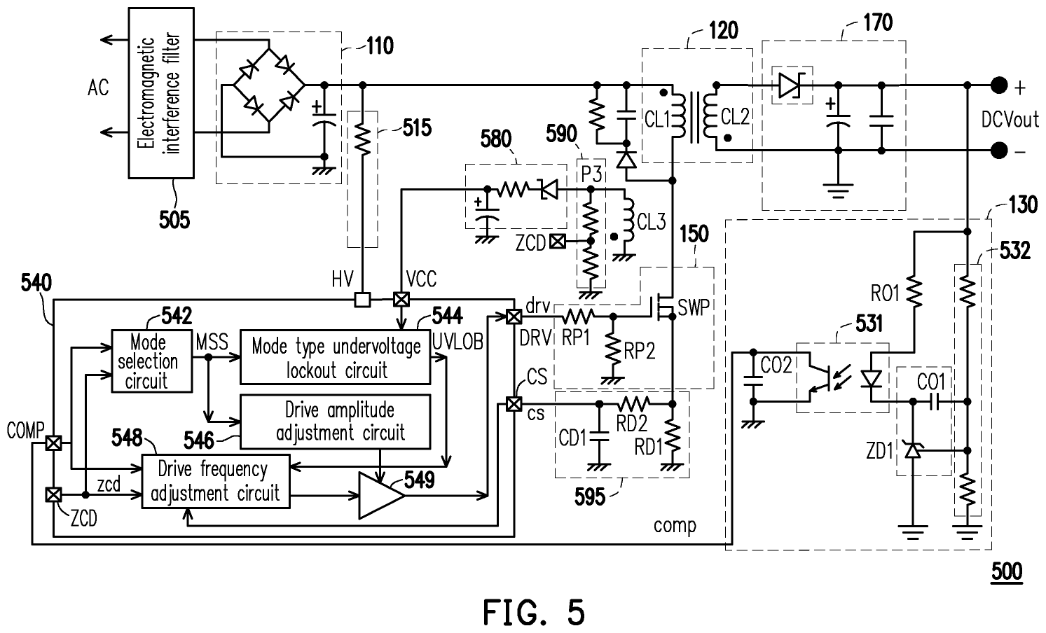

FIG. 5 is a schematic diagram of a transformer device 500 according to the second embodiment of the disclosure. The transformer device 500 in FIG. 5 has some circuits that are the same as the transformer device 100 in FIG. 1, they are marked with the same reference numerals and descriptions are omitted herein. The transformer device 500 in FIG. 5 further includes an electromagnetic interference (EMI) filter 505, a voltage activation circuit 515, an auxiliary winding CL3, an auxiliary winding voltage stabilizing circuit 580, a zero voltage and operation voltage dividing circuit 590, and a current detection circuit 595. The circuit structure of the primary-side controller 540, the power switch circuit 150, and the optical coupling circuit 130 in the transformer device 500 in FIG. 5 is shown in detail. The primary-side controller 540 may be implemented in chip form.

The primary-side controller 540 outputs a driving signal drv to control whether and when the power switch circuit 150 is turned on. The driving signal drv is in PWM signal mode. After the primary-side controller 540 is activated, it first generates the mode selection signal MSS based on the load detection signal comp from the optical coupling circuit 130 and the zero voltage detection signal zed from the zero voltage and operation voltage dividing circuit 590. Then, the primary-side controller 540 adjusts the amplitude (i.e., the voltage) of the driving signal drv according to the mode selection signal MSS, and adjusts the frequency or conduction time of the driving signal drv according to the current operating voltage of the primary-side controller 540.

The electromagnetic interference filter 505 is configured to perform electromagnetic interference filtering on the AC voltage obtained from the AC voltage source AC. The voltage activation circuit 515 (implemented as a resistor here) provides a high-voltage activation current and a detection signal to the high-voltage signal terminal HV of the primary-side controller 540. The primary-side controller 540 learns that the current output DC voltage DCVout is high voltage or low voltage through the high-voltage activation current and detection signal received by the high-voltage signal terminal HV. When the primary-side controller 540 determines that the voltage value of the output DC voltage DCVout is too high or too low, the primary-side controller 540 immediately stops the overall operation of the transformer device 500 to prevent the transformer device 500 and the load from being damaged due to excessively high or low voltage.

The auxiliary winding CL3 supplies power to the primary-side controller 540 through the high-frequency voltage conversion circuit 120 to generate a voltage at the terminal P3. The auxiliary winding voltage stabilizing circuit 580 stabilizes the voltage on the terminal P3 through a diode, a resistor and a capacitor, and provides this voltage to the operating voltage mapping terminal VCC of the primary-side controller 540 to serve as the operating voltage of the primary-side controller 540. The input terminal (i.e., terminal P3) of the zero voltage and operation voltage dividing circuit 590 is coupled to the output terminal of the auxiliary winding CL3. The zero voltage and operation voltage dividing circuit 590 divides the voltage at the terminal P3 to generate a zero voltage detection signal zcd, and provides it to the zero voltage detection terminal ZCD of the primary-side controller 540.

The optical coupling circuit 130 includes an optical coupler 531, a voltage dividing circuit 532, a resistor RO1, capacitors CO1 and CO2, and a voltage regulator ZD1. The voltage dividing circuit 532 divides the voltage on the DC output terminal DCVout and provides the divided voltage to one terminal of the capacitor CO1. One terminal of the resistor RO1 is coupled to the DC output terminal DCVout, and the other terminal of the resistor RO1 is coupled to one terminal of the light-emitting element in the optical coupler 531. The other terminal of the light-emitting element in the optical coupler 531 is coupled to the other terminal of the capacitor CO1 and one terminal of the voltage regulator ZD1. The other terminal of voltage regulator ZD1 is grounded. The two terminals of the capacitor CO2 are respectively coupled to the sensors in the optical coupler 531 (implemented as optical transistors herein). One terminal of the capacitor CO2 is also coupled to the load detection terminal COMP of the primary-side controller 540 to provide a load detection signal comp. When the voltage on the DC output terminal DCVout increases or decreases, the voltage value of the load detection signal comp increases or decreases accordingly.

The power switch circuit 150 includes a power switch SWP, and resistors RP1 and RP2. One terminal of the resistor RP1 is coupled to the driving voltage terminal DRV of the primary-side controller 540 to receive the driving signal drv. The control terminal of the power switch SWP receives the driving signal drv through the resistor RP1, so the power switch SWP is controlled by the driving signal drv. One terminal of the resistor RP2 is coupled to the other terminal of the resistor RP1 and the control terminal of the power switch SWP, and the other terminal of the resistor RP2 is grounded.

The current detection circuit 595 includes resistors RD1 and RD2, and a capacitor CD1. One terminal of the resistor RD1 is coupled to one terminal of the resistor RD2 and one terminal of the power switch SWP. The other terminal of resistor RD1 is grounded. The other terminal of the resistor RD2 is coupled to one terminal of the capacitor CD1 and the current detection terminal CS of the primary-side controller 540. The current detection circuit 595 provides a voltage detection signal corresponding to the current flowing through the power switch SWP to the primary-side controller 540 from one terminal of the capacitor CD1.

The primary-side controller 540 is coupled to the optical coupling circuit 130 and the power switch circuit 150. The primary-side controller 540 operates according to the operating voltage vcc received by the operating voltage mapping terminal VCC. The primary-side controller 540 sets the primary-side controller 540 to one of multiple operating modes according to the load detection signal comp and the zero voltage detection signal zcd, and adjusts an amplitude and a frequency of a pulse width modulation signal in the driving signal drv according to a set operating mode. The aforementioned operating modes include at least a first load mode (e.g., heavy load mode), a second load mode (e.g., light load mode), and a standby mode. When the set operating mode is the standby mode, the frequency and amplitude of the PWM signal generated by the primary-side controller 540 are lower than those of the first load mode (heavy load mode) and the second load mode (light load mode). The amplitude of the adjusted PWM signal corresponding to the first load mode (heavy load mode) is greater than the amplitude of the adjusted PWM signal corresponding to the second load mode (light load mode). The frequency of the adjusted PWM signal corresponding to the first load mode (heavy load mode) is higher than or equal to the frequency of the adjusted PWM signal corresponding to the second load mode (light load mode), thereby further distinguishing between heavy load and light load modes in more detail in loaded modes, and further reducing the power consumption of the transformer device 500 in the light load mode and the standby mode.

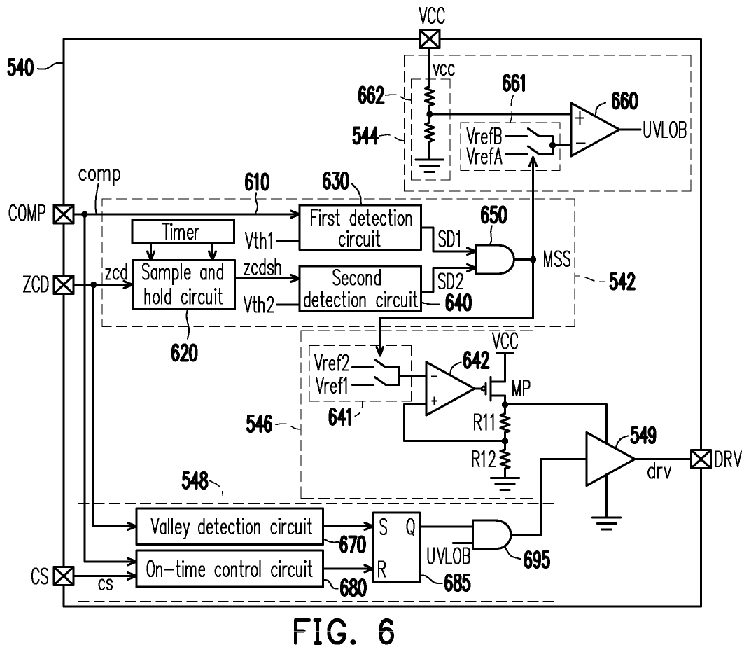

The primary-side controller 540 in FIG. 5 includes a load detection terminal COMP, a zero voltage detection terminal ZCD, an operating voltage mapping terminal VCC, a mode selection circuit 542, a mode type undervoltage lockout circuit 544, a drive amplitude adjustment circuit 546, a drive frequency adjustment circuit 548, and a buffer 549. The primary-side controller 540 of FIG. 5 is also referred to as the drive circuit of the transformer device 500. Here, the detailed circuit of each element in the primary-side controller 540 of FIG. 5 is described in detail with reference to FIG. 6.

FIG. 6 is a detailed circuit diagram of the primary-side controller 540 of FIG. 5. The load detection terminal COMP receives the load detection signal comp. The zero voltage detection terminal ZCD receives the zero voltage detection signal zcd. The operating voltage mapping terminal VCC receives the operating voltage vcc.

The mode selection circuit 542 includes a timer 610, a sample and hold circuit 620, a first detection circuit 630, a second detection circuit 640, and an AND gate 650. The first input terminal of the first detection circuit 630 receives the load detection signal comp. The second input terminal of the first detection circuit 630 receives the load threshold Vth1. The output terminal of the first detection circuit 630 generates the first detection signal SD1.

The load threshold Vth1 is a threshold configured to determine whether the current transformer device 500 is in the heavy load mode or the light load mode. In this embodiment, when the transformer device 500 is in the heavy load mode, the load detection signal comp should be greater than the load threshold Vth1, and the first detection signal SD1 is logic “0”; when the transformer device 500 is not in the heavy load mode, the load detection signal comp should be less than or equal to the load threshold Vth1, and the first detection signal SD1 is logic “1”.

The timer 610 is coupled to the sample and hold circuit 620. The input terminal of the sample and hold circuit 620 is coupled to the zero voltage detection terminal ZCD to receive the zero voltage detection signal zcd. The sample and hold circuit 620 receives and maintains the zero voltage detection signal zed according to the signal of the timer 542 to generate a sample and hold signal zcdsh.

The first input terminal of the second detection circuit 640 receives the sample and hold signal zcdsh. The second input terminal of the second detection circuit 640 receives the system power supply threshold Vth2. The output terminal of the second detection circuit 640 generates a second detection signal SD2.

The system power supply threshold Vth2 is a voltage configured to determine whether the output voltage of the current transformer device 500 is at the voltage during system standby. In this embodiment, the entire system power supply is 10V during normal operation, and the primary-side controller 540 also operates normally when its operating voltage is between 10V and 5V. In this embodiment, the value of the system power supply threshold Vth2 is set to the threshold when the output voltage of the transformer device 500 is 5V. At this time, the operating voltage of the primary-side controller 540 is close to the minimum voltage UVLO. When the output voltage of the transformer device 500 is high, the zero voltage detection signal zed should be greater than the system power supply threshold Vth2, and the second detection signal SD2 is logic “0”; when the output voltage of the transformer device 500 is low and may even be lower than the minimum voltage UVLO, the zero voltage detection signal zed should be less than or equal to the system power supply threshold Vth2, and the second detection signal SD2 is logic “1”. The first input terminal of the first AND gate 650 receives the first detection signal SD1, the second input terminal of the first AND gate 650 receives the second detection signal SD2, and the output terminal of the first AND gate 650 generates a mode selection signal MSS. Therefore, the mode selection circuit 542 compares the load detection signal comp with the load threshold Vth1 to generate the first detection signal SD1, compares the zero voltage detection signal zcd with the system power supply threshold Vth2 to generate the second detection signal SD2, and generates the mode selection signal MSS according to the first detection signal SD1 and the second detection signal SD2. In this embodiment, when the mode selection signal MSS is logic “1”, it indicates that the first detection signal SD1 is logic “1” (i.e., the transformer device 500 is in a light load or standby state), and the second detection signal SD2 is logic “1” (i.e., the output voltage of the transformer device 500 is equal to 5V or lower than 5V). Correspondingly, when the mode selection signal MSS is logic “0”, it indicates that the transformer device 500 is in the heavy load or medium load mode and the output voltage of the transformer device 500 is above 5V.

The mode type undervoltage lockout circuit 544 is coupled to the mode selection circuit 542. The mode type undervoltage lockout circuit 544 includes a first multiplexer 661, a first voltage dividing circuit 662, and a first comparator 660. Multiple input terminals of the first multiplexer 661 respectively receive multiple first candidate reference voltages. The control terminal of the first multiplexer 661 receives the mode selection signal MSS, and the output terminal of the first multiplexer 661 provides a first reference voltage selected from the aforementioned first candidate reference voltages. The first multiplexer 661 of this embodiment takes two input terminals as an example, which respectively receive the first candidate reference voltages VrefA and VrefB. The first candidate reference voltage VrefA is a voltage value configured to distinguish whether the transformer device 500 is in the heavy load mode or the medium and light load mode; the second candidate reference voltage VrefB is a voltage value configured to distinguish whether the transformer device 500 is in a light load mode or a standby state (i.e., no-load mode). When the mode selection signal MSS is logic “1”, the first multiplexer 661 is controlled by the mode selection signal MSS to use the second candidate reference voltage VrefB as the first reference voltage; when the mode selection signal MSS is logic “0”, the first multiplexer 661 is controlled by the mode selection signal MSS to use the first candidate reference voltage VrefA as the first reference voltage.

The input terminal of the first voltage dividing circuit 662 is coupled to the operating voltage mapping terminal VCC to receive the operating voltage vcc. The output terminal of the first voltage dividing circuit 662 generates a divided voltage signal and is coupled to the non-inverting input terminal of the first comparator 660. The inverting input terminal of the first comparator 660 is coupled to the output terminal of the first multiplexer 661 to receive the first reference voltage. The output terminal of the first comparator 661 provides the undervoltage lockout signal UVLOB. In this embodiment, when the mode selection signal MSS is logic “0” (in heavy load or medium load mode), the mode type undervoltage lockout circuit 544 compares the first candidate reference voltage VrefA with the divided voltage signal corresponding to the operating voltage vcc, thereby generating the enabled undervoltage lockout signal UVLOB when the divided voltage signal is less than the first candidate reference voltage VrefA. On the other hand, when the mode selection signal MSS is logic “1” (in the light load or standby state), the mode type undervoltage lockout circuit 544 compares the second candidate reference voltage VrefB with the divided voltage corresponding to the operating voltage vcc, thereby generating the enabled undervoltage lockout signal UVLOB when the divided voltage signal is less than the first candidate reference voltage VrefB. In this embodiment, the voltage value of the first candidate reference voltage VrefA is greater than the voltage value of the second candidate reference voltage VrefB.

The drive amplitude adjustment circuit 546 is coupled to the mode selection circuit 542. The drive amplitude adjustment circuit 546 selects one of multiple second candidate reference voltages (e.g., Vref1, Vref2) as the second reference voltage according to the mode selection signal MSS, and determines the amplitude of the PWM signal in the driving signal drv according to the second reference voltage and the operating voltage vcc. In detail, the drive amplitude adjustment circuit 546 includes a second multiplexer 641, a second amplifier 642, a P-type transistor MP, a first resistor R11, and a second resistor R12. The input terminals of the second multiplexer 641 respectively receive multiple second candidate reference voltages. The control terminal of the second multiplexer 641 receives the mode selection signal MSS, and the output terminal of the second multiplexer 641 provides a second reference voltage selected from the aforementioned second candidate reference voltages. The second multiplexer 641 of this embodiment takes two input terminals as an example, which respectively receive the second candidate reference voltages Vref1 and Vref2, and the second reference voltage is one of the second candidate reference voltages Vref1 and Vref2.

The inverting input terminal of the second amplifier 642 is coupled to the output terminal of the second multiplexer 641 to receive the second reference voltage. The control terminal of the P-type transistor MP is coupled to the output terminal of the second amplifier 642, the first terminal of the P-type transistor MP receives the operating voltage vcc, and the second terminal of the P-type transistor MP serves as the output terminal of the drive amplitude adjustment circuit 546. The first terminal of the first resistor R11 is coupled to the second terminal of the P-type transistor MP, and the second terminal of the first resistor R11 is coupled to the non-inverting input terminal of the second amplifier 642. The first terminal of the second resistor R12 is coupled to the second terminal of the first resistor R11 and the non-inverting input terminal of the second amplifier 642. The second terminal of the second resistor R12 is grounded.

The output terminal of the drive amplitude adjustment circuit 546 is coupled to the power supply terminal of the buffer 549. Therefore, the voltage value at the output terminal of the drive amplitude adjustment circuit 546 is the maximum amplitude value of the signal output by the buffer 549. Those who apply this embodiment may set the voltage values of the second candidate reference voltages Vref1 and Vref2 according to their needs, so that when the mode selection signal MSS is logic “0” (heavy load and medium load mode), the amplitude of the PWM signal in the driving signal drv is normal; when the mode selection signal MSS is logic “1” (light load and standby mode), the amplitude of the PWM signal in the driving signal drv is slightly lower than the aforementioned normal amplitude, thereby reducing switching loss.

The drive frequency adjustment circuit 548 is coupled to the mode type undervoltage lockout circuit 544. The drive frequency adjustment circuit 548 determines the frequency of the PWM signal in the driving signal drv according to the load detection signal comp, the zero voltage detection signal zcd, and the undervoltage lockout signal UVLOB. In this embodiment, the drive frequency adjustment circuit 548 also determines the frequency of the PWM signal in the driving signal drv according to the voltage detection signal cs combined with the aforementioned signals.

The drive frequency adjustment circuit 548 of FIG. 6 includes a valley detection circuit 670, an on-time control circuit 680, a set-reset flip-flop 685 and a second AND gate 695. The input terminal of the valley detection circuit 670 receives the zero voltage detection signal zcd. The first input terminal of the on-time control circuit 680 receives the load detection signal comp, and the second input terminal of the on-time control circuit 680 receives the voltage detection signal cs. The set terminal S of the set-reset flip-flop 685 is coupled to the output terminal of the valley detection circuit 670, and the reset terminal R of the set-reset flip-flop 685 is coupled to the output terminal of the on-time control circuit 680. The output terminal of the set-reset flip-flop 685 is coupled to the first input terminal of the second AND gate 695, and the second input terminal of the second AND gate 695 receives the undervoltage lockout signal UVLOB. The output terminal of the second AND gate 695 generates the waveform of the PWM signal in the driving signal drv. In the circuit structure of the drive frequency adjustment circuit 548 in FIG. 6, when the undervoltage lockout signal UVLOB is enabled (logic “0”), the output terminal of the second AND gate 695 only maintains a logic “0” and the driving signal drv is not generated; when the undervoltage lockout signal UVLOB is disabled (logic “1”), the second AND gate 695 generates the waveform of the PWM signal according to the mutual operation of the valley detection circuit 670, the on-time control circuit 680, and the set-reset flip-flop 685. Furthermore, the output terminal of the second AND gate 695 provides the waveform of the PWM signal to the input terminal of the buffer 549. In addition, the amplitude of the PWM signal is determined based on the voltage on the power supply terminal of the buffer 549. The power supply terminal of the buffer 549 is coupled to the output terminal of the drive amplitude adjustment circuit 546, and the input terminal of the buffer 549 is coupled to the output terminal of the drive frequency adjustment circuit 548 for generating the PWM signal in the driving signal drv.

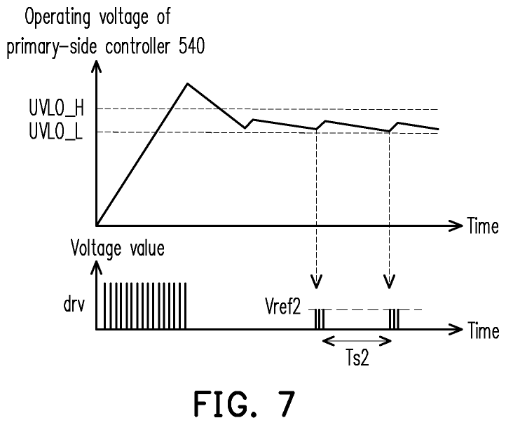

FIG. 7 is a waveform schematic diagram of the operating voltage, driving signal drv, and time of the primary-side controller 540 in the transformer device 500 of FIG. 5. Since the transformer device 500 in FIG. 5 may oscillate the operating voltage of the primary-side controller 540 between the lowest voltage UVLO_H and UVLO_L, the static power consumption of the primary-side controller 540 may be reduced. The drive amplitude adjustment circuit 546 in the primary-side controller 540 may reduce the amplitude of the PWM signal in the driving signal drv to the level of the second candidate reference voltage Vref2, thereby reducing the switching power consumption of the driving signal drv on the power switch. On the other hand, time Ts2 in FIG. 7 indicates that the driving signal drv is in the output pulse burst period. Comparing FIG. 4 with FIG. 7, the output pulse burst period Ts1 of FIG. 4 is obviously shorter than the output pulse burst period Ts2 of FIG. 7. Therefore, it indicates that the overall system stop time period of the transformer device 500 of the second embodiment of FIG. 7 is longer, and the switching loss is lower than that of the first embodiment.

The time Ts1 in FIG. 4 indicates that the driving signal drv is in the output pulse burst period. The longer the output pulse burst period of the driving signal drv, the longer the overall system stop time period of the transformer device 100, and the lower the switching loss.

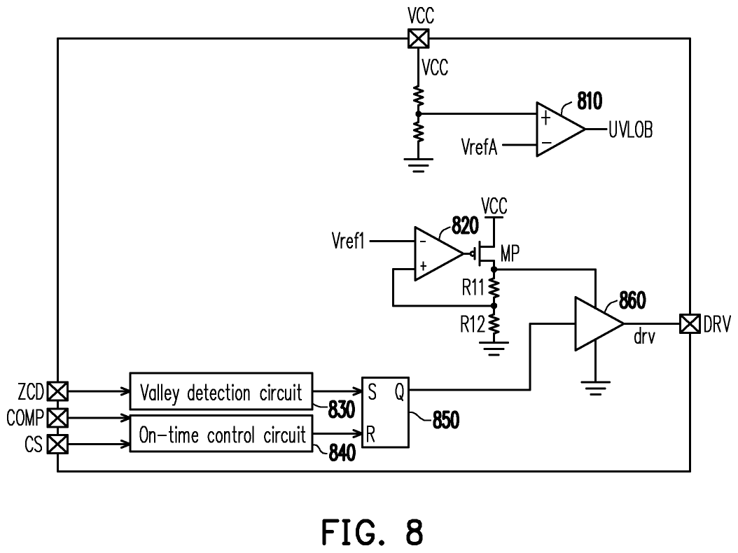

FIG. 8 is a detailed circuit diagram of a primary-side controller 840 in accordance with the third embodiment of the disclosure. The difference between the third embodiment of the disclosure and the second embodiment of FIG. 5 is that the circuit structures of the primary-side controllers 540 and 840 are different. The primary-side controller 840 in FIG. 8 includes comparators 810 and 820, a valley detection circuit 830, an on-time control circuit 840, a set-reset flip-flop 850, and a buffer 860. The non-inverting input terminal of the comparator 810 is coupled to the middle point of the two resistors of the voltage dividing circuit. One terminal of the voltage dividing circuit is coupled to the operating voltage mapping terminal VCC of the primary-side controller 840 to receive the operating voltage, and the other terminal of the voltage dividing circuit is grounded. The inverting input terminal of comparator 810 receives the reference voltage VrefA. The output terminal of comparator 810 generates an undervoltage lockout signal UVLOB. The non-inverting input terminal of comparator 820 receives the reference voltage Vref1. The coupling relationship and functions of the comparators 810 and 820, the P-type transistor MP, the resistors R11 and R12, the valley detection circuit 830, the on-time control circuit 840, the set-reset flip-flop 850, and buffer 860 are similar to the corresponding circuit structure described in FIG. 6.

In the third embodiment, in standby mode, the transformer coil located outside of the primary-side controller 840 naturally causes the operating voltage vcc of the primary-side controller 840 to fall to a lower voltage value. As a result, the operating voltage of the primary-side controller 840 naturally decreases. Furthermore, in this embodiment, the primary-side controller 840 may still function normally when its operating voltage falls below the minimum voltage UVLO. Consequently, the voltage value in the driving signal drv generated by the primary-side controller 840 also naturally decreases. In this way, this embodiment may be implemented without the selection circuits for multiple reference voltages in the mode selection circuit 542, the mode type undervoltage lockout circuit 544, and the drive amplitude adjustment circuit 546 in the second embodiment.

To sum up, the transformer device and the drive circuit for the transformer device of the embodiment of the disclosure determine whether the current operating mode of the drive circuit is a heavy load mode, a light load mode, or a standby mode by using the load detection signal and the zero voltage detection signal, thereby correspondingly adjust the amplitude and frequency of the PWM signal in the driving signal according to these operating modes. Specifically, in the heavy load mode, the amplitude and frequency of the PWM signal in the driving signal are normal, and the operating voltage of the drive circuit has not been adjusted. In light load mode, the amplitude of the PWM signal in the driving signal is reduced, and the frequency of the PWM signal may also be reduced to reduce the switching loss of the power switch. Moreover, the operating voltage of the drive circuit may also be slightly lowered in the light load mode, thereby reducing the static power consumption of the drive circuit. In standby mode, in addition to the operating voltage of the drive circuit being reduced, the generation of PWM signal in the driving signal is also stopped to avoid switching loss of the power switch. Thereby, the transformer device and its drive circuit of this embodiment may further save power consumption.

What is claimed is:

1. A transformer device, comprising:
an AC input terminal, providing an AC voltage;
a bridge rectifier circuit, converting the AC voltage into a first voltage;
a high-frequency voltage conversion circuit, comprising a primary winding, a secondary winding, and an auxiliary winding;
a power switch circuit, coupled to the primary winding, wherein the power switch circuit is controlled by a driving signal, the high-frequency voltage conversion circuit converts the first voltage into a DC voltage according to the primary winding, the secondary winding, and the power switch circuit;
an optical coupling circuit, generating a load detection signal according to the DC voltage;
a zero voltage and operation voltage dividing circuit, mapping an operating voltage proportional to an output voltage according to the auxiliary winding to provide a zero voltage detection signal; and
a primary-side controller, coupled to the optical coupling circuit and the power switch circuit, the primary-side controller operating according to the operating voltage, and
the primary-side controller setting the primary-side controller to one of a plurality of operating modes according to the load detection signal and the zero voltage detection signal, and adjusting an amplitude and a frequency of a pulse width modulation signal in the driving signal according to a set operating mode,
wherein the operating mode at least comprises a first load mode, a second load mode, and a standby mode.

2. The transformer device according to claim 1, wherein when the set operating mode is the standby mode, the frequency and the amplitude of the pulse width modulation signal generated by the primary-side controller are lower than the first load mode and the second load mode,
an amplitude of an adjusted pulse width modulation signal corresponding to the first load mode is greater than an amplitude of an adjusted pulse width modulation signal corresponding to the second load mode, a frequency of the adjusted pulse width modulation signal corresponding to the first load mode is higher than or equal to a frequency of the adjusted pulse width modulation signal corresponding to the second load mode.

3. The transformer device according to claim 1, wherein the primary-side controller comprises:
a load detection terminal, receiving the load detection signal;
a zero voltage detection terminal, receiving the zero voltage detection signal;
an operating voltage mapping terminal, obtaining an operating voltage, wherein the drive circuit operates according to the operating voltage;
a mode selection circuit, comparing the load detection signal and a load threshold to generate a first detection signal, comparing the zero voltage detection signal and a system power supply threshold to generate a second detection signal, and generating a mode selection signal according to the first detection signal and the second detection signal;
a mode type undervoltage lockout circuit, coupled to the mode selection circuit, selecting one of a plurality of first candidate reference voltages as a first reference voltage according to the mode selection signal, and comparing the first reference voltage with a divided voltage signal corresponding to the operating voltage to generate an undervoltage lockout signal;
a drive amplitude adjustment circuit, coupled to the mode selection circuit, selecting one of a plurality of second candidate reference voltages as a second reference voltage according to the mode selection signal, and determining the amplitude of the pulse width modulation signal in the driving signal according to the second reference voltage and the operating voltage;
a drive frequency adjustment circuit, coupled to the mode type undervoltage lockout circuit, determining a frequency of the pulse width modulation signal in the driving signal according to the load detection signal, the zero voltage detection signal, and the undervoltage lockout signal; and
a buffer, wherein a power supply terminal of the buffer is coupled to an output terminal of the drive amplitude adjustment circuit, an input terminal of the buffer is coupled to an output terminal of the drive frequency adjustment circuit, and the buffer is configured to generate the pulse width modulation signal.

4. The transformer device according to claim 3, wherein the primary-side controller further comprises:
a current detection terminal, configured to obtain a voltage detection signal generated from a current detection circuit by detecting a current flowing through a power switch in the power switch circuit,
wherein the drive frequency adjustment circuit determines the frequency of the pulse width modulation signal in the driving signal according to the load detection signal, the zero voltage detection signal, the undervoltage lockout signal, and the voltage detection signal.

5. The transformer device according to claim 3, wherein the mode selection circuit comprises:
a first detection circuit, wherein a first input terminal of the first detection circuit receives the load detection signal, a second input terminal of the first detection circuit receives the load threshold, an output terminal of the first detection circuit generates the first detection signal;
a sample and hold circuit;
a timer, coupled to the sample and hold circuit, wherein the sample and hold circuit receives and maintains the zero voltage detection signal according to a signal of the timer to generate a sample and hold signal;
a second detection circuit, wherein a first input terminal of the second detection circuit receives the sample and hold signal, a second input terminal of the second detection circuit receives the system power supply threshold, an output terminal of the second detection circuit generates the second detection signal; and
a first AND gate, wherein a first input terminal of the first AND gate receives the first detection signal, a second input terminal of the first AND gate receives the second detection signal, and an output terminal of the first AND gate generates the mode selection signal.

6. The transformer device according to claim 3, wherein the mode type undervoltage lockout circuit comprises:
a first multiplexer, wherein input terminals of the first multiplexer respectively receive the first candidate reference voltages, a control terminal of the first multiplexer receives the mode selection signal, an output terminal of the first multiplexer provides the first reference voltage;
a first voltage dividing circuit, wherein an input terminal of the first voltage dividing circuit is coupled to the operating voltage, an output terminal of the first voltage dividing circuit generates the divided voltage signal; and
a first comparator, wherein a non-inverting input terminal of the first comparator receives the divided voltage signal, an inverting input terminal of the first comparator is coupled to the output terminal of the first multiplexer to receive the first reference voltage, an output terminal of the first comparator provides the undervoltage lockout signal.

7. The transformer device according to claim 3, wherein the drive amplitude adjustment circuit comprises:
a second multiplexer, wherein input terminals of the second multiplexer respectively receive the second candidate reference voltages, a control terminal of the second multiplexer receives the mode selection signal, an output terminal of the second multiplexer provides the second reference voltage;
a second amplifier, wherein an inverting input terminal of the second amplifier is coupled to the output terminal of the second multiplexer to receive the second reference voltage;
a P-type transistor, wherein a control terminal of the P-type transistor is coupled to an output terminal of the second amplifier, a first terminal of the P-type transistor receives the operating voltage, a second terminal of the P-type transistor serves as the output terminal of the drive amplitude adjustment circuit;
a first resistor, wherein a first terminal of the first resistor is coupled to the second terminal of the P-type transistor, and a second terminal of the first resistor is coupled to a non-inverting input terminal of the second amplifier; and
a second resistor, wherein a first terminal of the second resistor is coupled to the second terminal of the first resistor and the non-inverting input terminal of the second amplifier, a second terminal of the second resistor is grounded.

8. The transformer device according to claim 4, wherein the drive frequency adjustment circuit comprises:
a valley detection circuit, wherein an input terminal of the valley detection circuit receives the zero voltage detection signal;
an on-time control circuit, wherein a first input terminal of the on-time control circuit receives the load detection signal, a second input terminal of the on-time control circuit receives the voltage detection signal;
a set-reset flip-flop, wherein a set terminal of the set-reset flip-flop is coupled to an output terminal of the valley detection circuit, and a reset terminal of the set-reset flip-flop is coupled to an output terminal of the on-time control circuit; and
a second AND gate, wherein a first input terminal of the second AND gate is coupled to an output terminal of the set-reset flip-flop, a second input terminal of the second AND gate receives the undervoltage lockout signal, an output terminal of the second AND gate generates a waveform of the pulse width modulation signal in the driving signal.

9. The transformer device according to claim 1, wherein an output terminal of the auxiliary winding is coupled to the operating voltage mapping terminal of the primary-side controller, the auxiliary winding provides the operating voltage to the operating voltage mapping terminal of the primary-side controller through the high-frequency voltage conversion circuit.

10. A drive circuit, configured to drive a transformer device, the drive circuit comprising:
a load detection terminal, obtaining a load detection signal;
a zero voltage detection terminal, obtaining a zero voltage detection signal;
an operating voltage mapping terminal, obtaining an operating voltage, wherein the drive circuit operates according to the operating voltage;
a mode selection circuit, comparing the load detection signal and a load threshold to generate a first detection signal, comparing the zero voltage detection signal and a system power supply threshold to generate a second detection signal, and generating a mode selection signal according to the first detection signal and the second detection signal;
a mode type undervoltage lockout circuit, coupled to the mode selection circuit, selecting one of a plurality of first candidate reference voltages as a first reference voltage according to the mode selection signal, and comparing the first reference voltage with a divided voltage signal corresponding to the operating voltage to generate an undervoltage lockout signal;
a drive amplitude adjustment circuit, coupled to the mode selection circuit, selecting one of a plurality of second candidate reference voltages as a second reference voltage according to the mode selection signal, and determining an amplitude of a pulse width modulation signal in a driving signal according to the second reference voltage and the operating voltage, wherein the driving signal is configured to drive a power switch in the transformer device;
a drive frequency adjustment circuit, coupled to the mode type undervoltage lockout circuit, determining a frequency of the pulse width modulation signal in the driving signal according to the load detection signal, the zero voltage detection signal, and the undervoltage lockout signal; and
a buffer, wherein a power supply terminal of the buffer is coupled to an output terminal of the drive amplitude adjustment circuit, an input terminal of the buffer is coupled to an output terminal of the drive frequency adjustment circuit, and the buffer is configured to generate the pulse width modulation signal in the driving signal.

11. The drive circuit according to claim 10, further comprising:
a current detection terminal, configured to obtain a voltage detection signal generated by detecting a current flowing through the power switch,
wherein the drive frequency adjustment circuit determines the frequency of the pulse width modulation signal in the driving signal according to the load detection signal, the zero voltage detection signal, the undervoltage lockout signal, and the voltage detection signal.

12. The drive circuit according to claim 10, wherein the mode selection circuit comprises:
a first detection circuit, wherein a first input terminal of the first detection circuit receives the load detection signal, a second input terminal of the first detection circuit receives the load threshold, an output terminal of the first detection circuit generates the first detection signal;
a sample and hold circuit;
a timer, coupled to the sample and hold circuit, wherein the sample and hold circuit receives and maintains the zero voltage detection signal according to a signal of the timer to generate a sample and hold signal;
a second detection circuit, wherein a first input terminal of the second detection circuit receives the sample and hold signal, a second input terminal of the second detection circuit receives the system power supply threshold, an output terminal of the second detection circuit generates the second detection signal; and
a first AND gate, wherein a first input terminal of the first AND gate receives the first detection signal, a second input terminal of the first AND gate receives the second detection signal, and an output terminal of the first AND gate generates the mode selection signal.

13. The drive circuit according to claim 10, wherein the mode type undervoltage lockout circuit comprises:
a first multiplexer, wherein a plurality of input terminals of the first multiplexer respectively receive the first candidate reference voltages, an output terminal of the first multiplexer provides the first reference voltage;
a first voltage dividing circuit, wherein an input terminal of the first voltage dividing circuit is coupled to the operating voltage, an output terminal of the first voltage dividing circuit generates the divided voltage signal; and
a first comparator, wherein a non-inverting input terminal of the first comparator receives the divided voltage signal, an inverting input terminal of the first comparator is coupled to the output terminal of the first multiplexer to receive the first reference voltage, an output terminal of the first comparator provides the undervoltage lockout signal.

14. The drive circuit according to claim 10, wherein the drive amplitude adjustment circuit comprises:
a second multiplexer, wherein input terminals of the second multiplexer respectively receive the second candidate reference voltages, a control terminal of the second multiplexer receives the mode selection signal, an output terminal of the second multiplexer provides the second reference voltage;
a second amplifier, wherein an inverting input terminal of the second amplifier is coupled to the output terminal of the second multiplexer to receive the second reference voltage;
a P-type transistor, wherein a control terminal of the P-type transistor is coupled to an output terminal of the second amplifier, a first terminal of the P-type transistor receives the operating voltage, a second terminal of the P-type transistor serves as the output terminal of the drive amplitude adjustment circuit;
a first resistor, wherein a first terminal of the first resistor is coupled to the second terminal of the P-type transistor, and a second terminal of the first resistor is coupled to a non-inverting input terminal of the second amplifier; and
a second resistor, wherein a first terminal of the second resistor is coupled to the second terminal of the first resistor and the non-inverting input terminal of the second amplifier, a second terminal of the second resistor is grounded.

15. The drive circuit according to claim 10, wherein the drive frequency adjustment circuit comprises:
a valley detection circuit, wherein an input terminal of the valley detection circuit receives the zero voltage detection signal;
an on-time control circuit, wherein a first input terminal of the on-time control circuit receives the load detection signal, a second input terminal of the on-time control circuit receives the voltage detection signal;
a set-reset flip-flop, wherein a set terminal of the set-reset flip-flop is coupled to an output terminal of the valley detection circuit, and a reset terminal of the set-reset flip-flop is coupled to an output terminal of the on-time control circuit; and
a second AND gate, wherein a first input terminal of the second AND gate is coupled to an output terminal of the set-reset flip-flop, a second input terminal of the second AND gate receives the undervoltage lockout signal, an output terminal of the second AND gate generates a waveform of the pulse width modulation signal in the driving signal.
